(19) United States
(12) Patent Application Publication
(10) Pub. No.: US 2023/0291044 A1
(43) Pub. Date: Sep. 14, 2023

(54) SOLID STATE THIN FILM BATTERY AND METHOD OF MANUFACTURE

(71) Applicant: Dyson Technology Limited, Wiltshire (GB)

(72) Inventor: Samuel James CHAPMAN, Gloucester (GB)

(73) Assignee: Dyson Technology Limited, Wiltshire (GB)

(21) Appl. No.: 18/020,408

(22) PCT Filed: Aug. 10, 2021
(86) PCT No.: PCT/GB2021/052066

§ 371 Date: Feb. 8, 2023

(30) Foreign Application Priority Data
Aug. 13, 2020 (GB) 2012667.8

(51) Int. Cl. H01M 50/204; H01M 50/296; H01M 10/44

(52) U.S. Cl. CPC H01M 50/204; H01M 50/296; H01M 10/441

(57) ABSTRACT

A solid state thin film battery including a plurality of solid state cells and a termination region is disclosed. Each cell is connected to the termination region by a current collector which includes a deformation element configured to deform under a lower load than the rest of the current collector. The properties, for example the geometry and/or materials of the portion of the current collector that forms the deformation element, may differ with respect to the properties of the rest of the current collector. Methods of manufacturing and operating such a battery are also disclosed.

### FIELD OF THE INVENTION

The present disclosure relates to solid state thin film batteries. More particularly, but not exclusively, this invention concerns a solid state thin film battery comprising a current collector having a deformation element. The invention also concerns such a current collector, and a method of manufacturing such a solid state thin film battery.

### BACKGROUND OF THE INVENTION

A solid state battery may be defined as a battery that uses solid electrodes and a solid electrolyte. Solid state thin film batteries may comprise a stack of layers (for example in the region of three hundred layers per battery), each layer comprising a solid state cell and a current collector connecting each solid state cell to a termination region of the battery. The solid state cells comprise the active material of the battery. Each solid state cell may comprise an anode layer, a cathode layer and an electrolyte. For a thin film solid state battery the thickness of the layers that make up the anode, cathode and electrolyte may be in the order of microns (0.001 mm). Each current collector may comprise a substrate and an electrically conductive layer on the substrate. Alternatively, each current collector may comprise an electrically conductive substrate. The termination region may be configured to connect together the solid state cells and to provide a surface for tabbing. The battery may comprise one or more tabs (for example a positive and negative tab) via which the battery can be connected to an external circuit to provide power thereto. Each tab may be in electrical contact, for example mounted on, a termination region of the battery.

During charging and discharging of the battery the volume of the solid state cells may change, for example the solid state cells may expand during charging and contract during discharge. When multiplied across all the cells in a stack, expansion and contraction of the solid state cells may give rise to significant stresses in the stack, as the solid state cells expand and/or contract while other elements of the battery, for example the termination region, do not. The stress experienced may be sufficient to cause plastic deformation of the current collector and/or delamination of the conductive layer from the substrate. Particular stress concentrations may be experienced in the region of the current collector adjacent to an edge of a cell and/or the region where the current collector is attached to the termination region.

In view of the above, it would be advantageous to provide a way of reducing the risk of damage to a solid state thin film battery as a result of the expansion and/or contraction of the solid state cells during cycling of the battery.

Changing the materials used in the battery, for example in the current collector and/or the termination region may reduce the risk of damage to the battery as a result of cell expansion and/or contraction however the identification of suitable materials is not straightforward. For example, it is not currently known if an appropriate material for the termination region could be manufactured using existing techniques. Any change in the substrate material could result in either an increase in the stress on the cell or an increase in the deformation of the current collector as a result of expansion and/or contraction of the cell during cycling, neither of which are desirable in a solid state battery.

The present invention seeks to mitigate the above-mentioned problems. Alternatively or additionally, the present invention seeks to provide an improved solid state thin film battery and improved methods of manufacturing such a battery.

### SUMMARY OF THE INVENTION

The present invention provides a solid state thin film battery comprising a plurality of solid state cells and/or a termination region. Each cell may be connected to the termination region by a current collector. It may be that each current collector comprises a deformation element. The deformation element may be configured to deform under a lower load than the rest of the current collector.

Thus, batteries in accordance with the present invention may comprise a deformation element configured to deform before the rest of the current collector thereby providing a measure of control over the way in which the current collector deforms under load. For example, the deformation element may be designed to deform once a particular threshold load is reached and/or the location of the deformation element on the current collector may determine where deformation of the current collector occurs. It may be that controlling the deformation of the current collector in this way reduces the maximum stress experienced by the current collector thereby reducing the risk of damage, for example plastic deformation and/or delamination of the current collector, as a result of solid state cell expansion. Additionally or alternatively, use of the deformation element may allow deformation of the current collector at lower levels of load thereby reducing stress on the solid state cell.

As used herein the phrase ‘deform under a lower load than the rest of the current collector’ may be understood as referring to the force required to deform the deformation element being less than the force required to deform the rest of the current collector. Said force may be the force exerted on the current collector by the cell to which it is connected as result of expansion and/or contraction of the cells in the battery, optionally while the termination region remains substantially undeformed. Deformation may be defined as a change in the shape of the deformation element, for example an increase or decrease in the length of the deformation element. The length of the deformation element may be defined as the distance from one end of the deformation element to the other along the longitudinal axis of the deformation and/or current collector.

It will be appreciated that, as used herein, the term ‘connected’ may be understood as ‘electrically connected’ unless otherwise stated.

The properties, for example the structure, geometry and/or materials, of the deformation element may differ from the properties of the rest of the current collector such that the deformation element deforms at a lower load than the rest of the current collector. The properties, for example the structure, geometry and/or materials, of the portion of the current collector that forms the deformation element may differ from the properties of the rest of the current collector such that the deformation element deforms at a lower load than the rest of the current collector.

The deformation element may be configured to elastically deform under a lower load than the rest of the current collector.

The battery may be configured such that the length of the deformation element changes from a first length to a second length as the volume of the solid state cells changes from a first volume to a second volume, for example as the solid state cells undergo one of expansion or contraction. The battery may be configured such that the length of the deformation element changes from the second length to the first length as the volume of the solid state cells changed from the second volume to the first volume, for example as the solid state cells undergo the other of expansion and contraction. The deformation element may be configured to deform elastically, such that in normal use the length of the element changes for between the first and second lengths repeatedly.

The current collector may comprise a current collecting layer, for example an electrically conductive layer, on a substrate. The deformation element may comprise a portion of the current collecting layer and a portion of the substrate. Alternatively, for example in the case that the current collector comprises an electrically conductive substrate, the deformation element may comprise a portion of the current collecting layer only.

The properties, for example the structure, geometry and/or materials, of said portion of the substrate (the portion of the substrate comprised within the deformation element) may differ from the properties of the rest of the substrate such that said portion of the substrate deforms at a lower load than the rest of the substrate. Changing the properties of the substrate in order to provide the deformation element may facilitate manufacture of the current collector and/or allow for the deformation element to be provided without any changes to the current collecting layer (the properties of the current collecting layer being more important in terms of the design and function of the battery than the properties of the substrate). The properties, for example the structure, geometry and/or materials, of the current collecting layer may be substantially identical as between the deformation element and the rest of the current collector such that the current collecting layer comprised within the deformation element has similar electrical and/or mechanical properties to the rest of the current collecting layer, for example so that current collecting layer comprised within the deformation element deforms at a similar load to the rest of the current collecting layer.

The current collector and/or the substrate may comprise first, second and third portions. The deformation element may comprise the second portion of the current collector and/or substrate. Thus, the deformation element may comprise a second portion of the current collector and/or the substrate, the properties of the second portion differing with respect to the other portions of the current collector and/or substrate (for example the first and third portions and any further portions, if present) such that the second portion of the current collector and/or substrate deforms at a lower load than the rest of the current collector and/or substrate (including the first and third portions and any further portions, if present). The properties of the first and third portions (and any further portions, if present) may differ with respect to each other. Alternatively, the properties of the first and third portions (and any further portions, if present) may be substantially identical.

It may be that the deformation element comprises a plurality of recesses formed in a region (or second portion) of the current collector. The plurality of recesses may be formed in said portion of the substrate (the portion of the substrate comprised within the deformation element).

It may be that the deformation element comprises a plurality of through-holes formed in a region (or second portion) of the current collector. The plurality of through-holes may be formed in said portion of the substrate (the portion of the substrate comprised within the deformation element).

It may be that the cross-sectional area of the deformation element is less than the cross-sectional area of the rest of the current collector. The cross-sectional area of said portion of the substrate (the portion of the substrate comprised within the deformation element) may be less than the cross-sectional area of the rest of the substrate. For example, said portion of the substrate may have a reduced thickness and/or width in comparison to the rest of the substrate. Said reduced thickness and/or width may be achieved using one or more recesses and/or through-holes to reduce the thickness and/or width of the deformation element (or substrate) respectively.

In some cases, providing a reduced cross-sectional area may facilitate manufacture of the deformation element in comparison to providing a plurality of recesses and/or through-holes. However, the use of a plurality of recess and/or through holes to provide the deformation element may provide additional design flexibility in comparison to a reduced cross-sectional area.

It may be that the deformation element comprises structure configured to move between a first configuration to a second configuration such that the dimensions, for example the length, of the deformation element changes as the structure moves between the first and second configurations. Thus, the deformation element may deform as a result of the change in configuration of the structure. The deformation element may comprise structure that is reconfigurable between the first and second configurations, for example the structure may be reconfigurable by folding, unfolding, pivoting and/or sliding. Thus, it may be that the position and/or orientation of a portion of the structure relative to the rest of the structure is different as between the first and second configurations. It may be that in the first configuration the deformation element has a first length and in the second configuration the deformation has a second, different, length. The structure may comprise a plurality of folded portions such that the structure moves between the first and second configurations as the folded portions fold and unfold.

It may be that the substrate comprises a first side and a second side, opposite to the first side. The current collecting layer may be formed on the first side of the substrate. Each recess (if present) may be formed in the second side of the substrate. For example, each recess may extend from the second side of the substrate towards the first side of the substrate. Provision of one or more recesses on the opposite side of the substrate to the current collecting layer may facilitate manufacturing of the deformation element.

It may be that a layer of insulating material, for example an insulating adhesive, is located on each current collector between the cell and the termination region to separate the current collector from an adjacent current collector, for example to separate a current collector of one layer from a current collector of another layer. Provision of such a layer of electrically insulating material may reduce the risk of a short between cells. Provision of such a layer of electrically insulating adhesive may provide adhesion during stacking.

The deformation element may be spaced apart from the ends of the current collector. Thus, the current collector and/or substrate may comprise, for example in order along its length, the first portion, the second portion and the third portion, the deformation element comprising the second portion.

It may be that the deformation element is located between the cell and the termination region. It may be that the deformation element is located closer to the cell than the termination region. In the case that the battery comprises a layer of insulating material (for example insulating adhesive) on the current collector, the deformation element may be located between the cell and the layer of insulating adhesive. Alternatively, it may be that the deformation element is located closer to the termination region than the cell.

It may be that the current collector comprises two or more deformation elements. Each deformation element may be spaced apart from any other deformation element along the longitudinal axis of the current collector. It may be that the load at which a first deformation element deforms is lower than the load at which a second deformation element deforms, the first and second deformation elements (and any further deformation elements if present) being configured to deform under a lower load than the rest of the current collector. In the case that the current collector comprises two or more deformation elements, the first and second deformation elements may be located on either side of the layer of insulating material.

It may be that the termination region comprises one or more conductive paths, said conducting path(s) connecting the plurality of current collectors. It may be that an electrically conductive material, for example an electrically conductive adhesive, connects the plurality of current collectors. That is to say, the conductive path(s) may comprise a layer of electrically conductive material, for example adhesive. It may be that a metal pathway, for example a spray coated metal layer, connects the plurality of current collectors. That is to say, the conductive path(s) may comprise a metal layer, for example a spray coated metal layer.

It may be that battery comprise one or more tabs connected to the termination region. The one or more conductive paths may connect the plurality of current collectors to the one or more tabs.

The thickness of the substrate (outside of the deformation element in the case the deformation element comprises a region of reduced thickness) may be from 2.5 to 3.5 microns inclusive, for example 3 microns. The thickness of the conducting layer may be from 0.4 to 0.6 microns inclusive, for example 0.5 microns. The distance along a current collector between the cell and the termination region and between the cell and the insulating material (if present) may be in the order of tens of microns, for example from 30 to 80 microns inclusive. The length of the crumple zone (the distance the crumple zone extends along the current collector) may be in the order of tens of microns, for example from 10 to 30 microns inclusive. The diameter and/or width of a recess (if present) and/or through-hole (if present) may be in the order of one micron, for example from 0.5 to 1.5 microns inclusive.

Suitable materials for use in the current collector (and elsewhere in the battery) will be known to the skilled person. The substrate may comprise, for example consist and/or consist essentially of a polymer material, for example Polyimide or Polyethylene terephthalate (PET) or similar, or in the case of an electrically conductive substrate, copper. The conducting layer may comprise, for example consist and/or consist essentially of an electrically conductive metal, for example platinum and/or nickel.

According to a second aspect of the invention there is also provided a current collector suitable for use as the current collector of any other aspect. Such a current collector comprises a deformation element as described above.

According to a third aspect of the invention there is also provided a method of manufacturing a current collector in accordance with any other aspect and/or a solid state thin film battery comprising a plurality of solid state cells and a termination region. It may be that each cell is connected to the termination region by a current collector. The method may comprise providing a deformation element in a region of the or each current collector, the deformation element may be configured to deform under a lower load than the rest of the current collector. Said deformation element may have any of the features described above with reference to the first aspect.

It may be that each current collector comprises a conducting layer on a substrate and the method comprises forming the conducting layer on the substrate and then removing material from the substrate to form the deformation element. The method may comprise removing material to produce one or more recesses and/or through-holes in the substrate and/or to reduce the cross-sectional area of the substrate. It may be that the conducting layer is formed on a first side of the substrate. It may be that material is removed from the substrate from a second, opposite, side of the substrate. Thus, material may be removed from the second (for example back) side of the substrate while leaving the conducting layer on the first (for example front) side of the substrate substantially undisturbed.

The step of removing material from the substrate may comprise machining the substrate, for example laser machining or mechanical machining of the substrate. Additionally or alternatively, the step of removing material from the substrate may comprise etching the substrate.

The method may comprise assembling first, second and third portions (and further portions, if present) of the current collector and/or substrate to form the current collector and/or substrate, wherein the properties of the second portion differs with respect to the other portions (for example the first and third portions and any other portions, if present) such that the second portion deforms under a lower load that the other portions.

The method may comprise providing a structure configured to move between first and second configurations.

The method may comprise repeating the steps of forming the conducting layer on a substrate and then removing material and/or assembling components to produce a plurality of current collectors. The method may comprise assembling the plurality of current collectors into a stack, each layer of the stack comprising at least one current collector and a solid state cell. Each layer of the stack may further comprise a layer of insulating adhesive on the current collector. The method may comprise connecting each current collector to a termination region of the battery, such that all of the layers are connected via the termination region.

According to a fourth aspect of the invention, there is provided a method of operating a solid state thin film battery comprising a plurality of solid state cells and a current collector extending between each solid state cell and a termination region, each current collector comprising a deformation element configured to deform at a lower load than the rest of the current collector. The method may comprise charging and discharging the battery in a plurality of cycles. It may be that the volume of each solid state cell changes (for example expands and/or contracts) during said plurality of cycles thereby exerting a load on the current collectors. It may be that the volume of the termination region remains substantially unchanged during said plurality of cycles. The method may comprise the difference in expansion between the termination region and the solid state cells causing the current collector to experience a load. The method may comprise the deformation element starting to deform when the load on the current collector reaches a first threshold level. It may be that the rest of the current collector does not deform when the load on the current collector reaches a first threshold level. It may be that the rest of the current collector does not deform unless or until the load on the current collector reaches a second threshold level, the second threshold level being higher than the first threshold level. It may be that the current collector elastically deforms while the load on the current collector is between the first and second threshold levels. It may be that, in normal operation, the load on the current collector remains below the second threshold level as the battery is charged and discharged.

It may be that during each of said plurality of cycles the solid state cells expands and contracts. It may be that during each cycle the deformation element deforms when the load on the current collector reaches a first threshold level as a result of one expansion and contraction of the solid state cells. It may be that the deformation element returns towards, for example to, its undeformed shape as the solid state cells undergo the other of expansion and contraction. Thus, the deformation of the deformation element may be elastic (rather than plastic) and the shape of the deformation element may be substantially the same at the start and end of each cycle.

It will of course be appreciated that features described in relation to one aspect of the present invention may be incorporated into other aspects of the present invention. For example, the method of the invention may incorporate any of the features described with reference to the apparatus of the invention and vice versa.

### DESCRIPTION OF THE DRAWINGS

Embodiments of the present invention will now be described by way of example only with reference to the accompanying schematic drawings of which:

FIG. 1 shows a schematic view of a portion of a solid state thin film battery according to a first embodiment of the invention;

FIG. 2 shows a schematic plan view of a portion of a current collector suitable for use in embodiments of the invention, including the first embodiment;

FIG. 3 shows a schematic plan view of a portion of a current collector suitable for use in embodiments of the invention, including the first embodiment;

FIG. 4 shows a schematic side view of a portion of a current collector suitable for use in embodiments of the invention, including the first embodiment;

FIG. 5 shows a schematic side view of a portion of a current collector suitable for use in embodiments of the invention, including the first embodiment;

FIG. 6 shows a schematic side view of a portion of a current collector suitable for use in embodiments of the invention, including the first embodiment;

FIG. 7 shows an example method of manufacturing a solid state thin film battery in accordance with the invention, and

FIG. 8 shows an example method of operating a solid state thin film battery in accordance with the invention.

### DETAILED DESCRIPTION

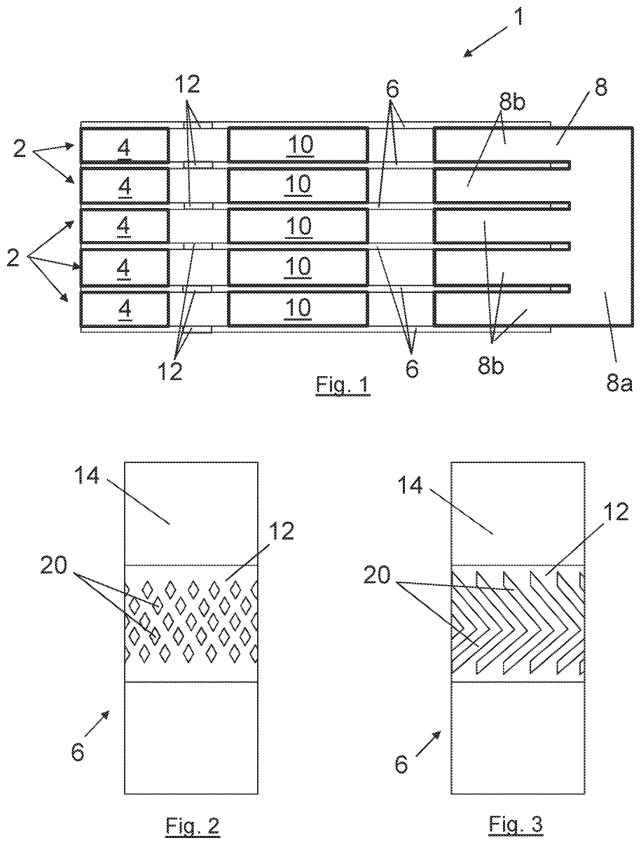

FIG. 1 shows a schematic view of a portion of a solid state thin film battery 1 in accordance with an embodiment of the invention. It will be appreciated that the portion of the battery shown in FIG. 1 represents part of one end of the battery, a similar structure being present at the other end of the battery. As shown in FIG. 1 the battery 1 includes five layers 2 stacked one atop the other (it will be appreciated that a battery may include may more layers in practice). Each layer 2 comprises a solid state cell 4 located at one end of a current collector 6. In the portion of the battery shown in FIG. 1 current collector 6 is connected to one of the anode or cathode of solid state cell 4, at the other end of the battery the current collectors are connected to the other of the anode or cathode. The other end of the current collector 6 connects to a termination region 8 of the battery 1. In FIG. 1, the termination region 8 comprises a base region 8a and a series of projections 8b extending outward from the base region 8a towards the solid state cell 4. Each current collector 6 connects to and extends along a portion of a projection 8b. It will be appreciated that the shape of the termination region 8 may differ in other embodiments, it being sufficient that the termination region connects together the various current collectors 6. The termination region may be formed using a conductive adhesive, a spray coated metal layer or any other appropriate material that provides a conductive pathway between the current collectors. In the embodiment of FIG. 1, each layer 2 also comprises an insulating adhesive 10 located on the current collector 6 between the termination region 8 and the solid state cell 4. In other embodiments the insulating material may be non-adhesive or may be absent altogether. Each current collector 6 comprises a deformation element 12. In the embodiment of FIG. 1, the deformation element 12 of each layer 2 is located between the solid state cell 4 and the insulating adhesive 10. In other embodiments, the deformation element 12 of each layer 2 may be located anywhere between the solid state cell 4 and the termination region 8, particularly the distal end of the projections 8a. In the same or yet further embodiments more than one deformation element may be present, the deformation elements being spaced apart along the current collector. The deformation element 12 is configured to deform under a lower level of load generated by the expansion of the cells 4 than the rest of the current collector 6. Different possible configurations of the deformation element and the structure of the current collector 6 are described in more detail in connection with FIGS. 2 to 5. As shown in, for example FIG. 4, each current collector comprises a substrate 14 on which an electrically conductive layer 16 is supported. Suitable materials for the various elements described above will be known to the skilled person. By way of example only the substrate may be a polymer. The electrically conductive layer may a metal layer, for example a platinum layer. In other embodiments, the substrate itself may be electrically conductive, in which case layer 16 may be absent.

In a typical example of the arrangement of FIG. 1 the substrate 14 of the current collector is in the region of 3 microns thick, the electrically conductive layer 16 having a thickness of around 0.5 microns. The distance the deformation element 12 extends along the length of the current collector 6 may be in the range of 10 microns to 50 microns.

Use of a deformation element configured to deform under a lower load than the rest of the current collector may reduce the risk of damage due to solid state cell expansion in batteries in accordance with the present embodiment in comparison with prior art batteries. A deformation element may provide an area where deformation of the current collector can occur at relatively low levels of stress thereby reducing the stress on the cell and/or reducing the maximum strain on the substrate. For example, allowing some deformation in a deformation element located at a first region of the current collector (for example spaced apart from the solid state cell or termination region) may reduce the stress and strain experienced by the current collector elsewhere (for example in the region immediately adjacent the cell or termination region) thereby reducing the risk of damage to the battery.

FIGS. 2 and 3 show schematic plan views of a current collector 6 having a deformation element 12 in accordance with two different example embodiments of the invention. For the sake of clarity, the electrically conductive layer 16 is not shown. In FIG. 2 a series of through-holes 20 which appear diamond shaped when viewed in plan are formed in the substrate. In FIG. 3 the through-holes 20 appear chevron shaped when viewed in plan. Thus, in the embodiments of FIGS. 2 and 3 the deformation element 12 is provided by forming thorough-holes 20 in the substrate 14.

FIG. 4 shows a schematic side view of a current collector 6 having a deformation element 12 in accordance with yet another example embodiment of the invention. In FIG. 4 the electrically conductive layer 16 is shown on top of the substrate 14. The thickness of a first region 14a of the substrate 14 of the current collector 6 is reduced in comparison to the thickness of the substrate 14 in the rest of the current collector 6. Thus, in the embodiment of FIG. 4 the deformation element 12 (indicated with a dashed line in FIG. 4) is provided by varying the geometry of the substrate 14. In the present embodiment the thickness is varied, but it will be appreciated that the width could be varied instead of or as well as the thickness.

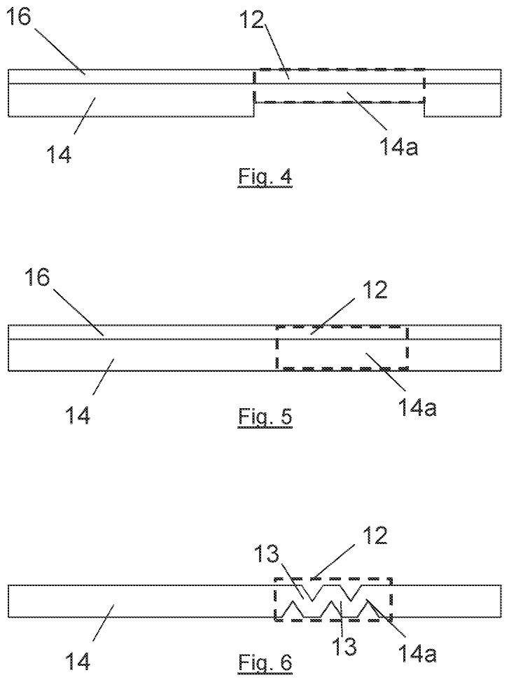

FIG. 5 shows a schematic side view of a current collector 6 having a deformation element 12 in accordance with yet another example embodiment of the invention. In FIG. 5 the electrically conductive layer 16 is shown on top of the substrate 14. The thickness of the substrate 14 of the current collector 6 in FIG. 5 is constant (although it need not necessarily be so). A first region 14a of the substrate 14 is made from a different material to the rest of the substrate 14. The material used in the first region 14a has a lower Young's modulus than that of the material used for the rest of the substrate. For example, two different polymer materials may be used for the substrate. Thus, in the embodiment of FIG. 5 the deformation element 12 (indicated with a dashed line in FIG. 5) is provided by varying the material from which the substrate 14 is made.

FIG. 6 shows a schematic side view of a current collector 6 having a deformation element 12 in accordance with yet another example embodiment of the invention. A first region 14a of the substrate 14 comprises a plurality of folded portions 13 giving the substrate 14 a zig-zag appearance when viewed side-on as in FIG. 6. In use, the folded portions 13 unfold or fold under loading thereby resulting in a change in the length of the deformation element 12 (indicated with a dashed line in FIG. 6). Thus, in the embodiment of FIG. 6 the deformation element 12 has a structure that changes configuration thereby deforming the deformation element 12. In other embodiments, different structures that change configuration in order to alter the length of the deformation element may be used.

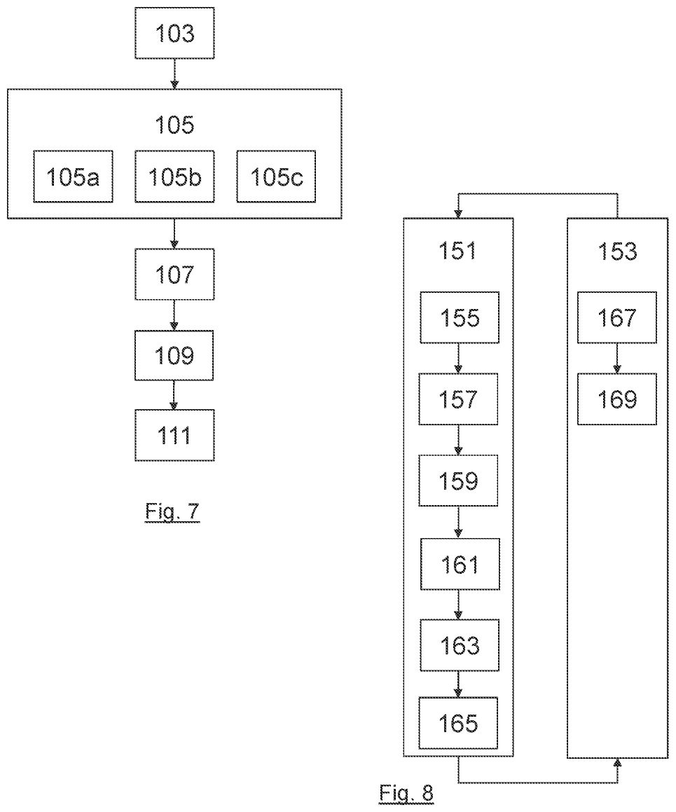

FIG. 7 shows a flow chart of an example method of manufacturing a battery in accordance with the present invention. The method may comprise providing 103 a layer of electrically conductive material, for example a platinum layer, on a substrate, for example a polymer substrate, to produce a current collector. Various methods are known to the skilled person for depositing such a layer. After providing 103 a layer of conductive material, the method comprises removing 105 material from the substrate, for example to produce one or more recesses and/or through holes in the substrate and/or to reduce the cross-sectional area of the substrate, thereby creating a deformation element. The step of removing 105 material may comprise one or more of etching 105a, laser machining 105b or mechanical machining 105c of the substrate. Optionally, the method comprises providing 107 a solid state cell on the current collector to form a layer, and assembling 109 a plurality of layers into a stack. Optionally, the method comprises providing 111 a termination region, for example by providing a conductive pathway using a metal foil or conductive adhesive, that connects the current collectors in the stack. Optionally, the step of removing 105 material is carried out on the opposite side of the substrate to the electrically conductive material. The steps of removing 105 material from the substrate, providing 107 a solid state cell on the current collector to form a layer, assembling 109 a plurality of layers into a stack and providing 111 a termination region may be carried out in any order. In some embodiments, the step of removing 105 material may be carried out after the step of providing 107 a solid state cell but prior to assembling 109 a plurality of layers and providing 111 a termination region.

While the method is described above with reference to removing material from the substrate in order to form the deformation element it will be appreciated that the deformation element may be produced by assembling components to form the substrate. For example, the method may comprise assembling a plurality of substrate portions, at least one of said portions comprising a material having a lower Young's Modulus than the material of the other portions and/or having a geometry that differs from the other portions such that said at least one portion when assembled with the other portions forms a deformation element. Alternatively, the deformation element may be produced by providing, for example assembling, a structure configured to move between first and second configurations.

FIG. 8 shows a flow chart of an example method of operating a battery in accordance with the present invention. The method may comprise repeatedly charging 151 and discharging 153 the battery, for example a battery in accordance with the first embodiment. During charging 151 the cells of the battery expand 155 and exert 157 a load on the current collectors. The load increases until a first threshold is reached 159 and the deformation element begins to deform 161 while the rest of the current collector remains undeformed. The rest of the current collector does not begin to deform 165 unless and until the load exerted on the current collectors by the cells reaches 163 a second, higher, threshold. In some example methods, during normal operation, the load exerted on the current collectors does not reach the second threshold. During discharging 153 the cells of the battery contract 167 and the deformation element returns 169 to its original shape. Thus, in the present example method the deformation element elastically deforms while the load remains below the second threshold. In some other embodiment the deformation element may plastically deform. It will be appreciated that while in the present example method the deformation element deforms with an expansion of the cells and returns to its original shape when the cells contract, in other example methods it may be a contraction of the cells that causes deformation of the deformation element and expansion of the cells that returns the deformation element to its undeformed shape.

Whilst the present invention has been described and illustrated with reference to particular embodiments, it will be appreciated by those of ordinary skill in the art that the invention lends itself to many different variations not specifically illustrated herein.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. A solid state thin film battery comprising
a plurality of solid state cells and a termination region, each cell being connected to the termination region by a current collector; and
wherein each current collector comprises a deformation element, the deformation element being configured to deform under a lower load than the rest of the current collector.

2. The solid state thin film battery according to claim 1, wherein the current collector comprises a current collecting layer on a substrate, the deformation element comprising a portion of the current collecting layer and a portion of the substrate.

3. The solid state thin film battery according to claim 2, wherein the deformation element comprises a plurality of recesses formed in a region of the current collector.

4. The solid state thin film battery according to claim 2, wherein the deformation element comprises a plurality of through-holes formed in a region of the current collector.

5. The solid state thin film battery according to claim 2, wherein the cross-sectional area of the deformation element is less than the cross-sectional area of the rest of the current collector.

6. The solid state thin film battery according to claim 1, wherein a layer of insulating material is located on each current collector between the solid state cell and the termination region to separate the current collector from an adjacent current collector.

7. The solid state thin film battery according to claim 1, wherein the deformation element is located between the solid state cell and the termination region.

8. The solid state thin film battery according to claim 1, wherein the termination region comprises a conductive path connecting the plurality of current collectors.

9. A current collector suitable for use as the current collector of claim 1.

10. A method of manufacturing a solid state thin film battery comprising a plurality of solid state cells and a termination region, each solid state cell being connected to the termination region by a current collector, the method comprising providing a deformation element in a region of each current collector, the deformation element being configured to deform under a lower load than the rest of the current collector.

11. The method according to claim 10, wherein each current collector comprises a conducting layer on a substrate and the method comprises forming the conducting layer on the substrate and then removing material from the substrate to form the deformation element.

12. The method according to claim 11, wherein the step of removing material from the substrate comprises machining the substrate.

13. The method according to claim 11, wherein the step of removing material from the substrate comprises etching the substrate.

14. The method according to claim 10, wherein each current collector comprises a conducting layer on a substrate and the method comprises assembling first, second and third portions of the substrate to form the substrate, wherein the properties of the second portion differ with respect to the other portions of the substrate such that the second portion of the substrate deforms under a lower load that the other portions.

15. A method of operating a solid state thin film battery comprising a plurality of solid state cells and a current collector extending between each solid state cell and a termination region, each current collector comprising a deformation element configured to deform under a lower load than the rest of the current collector, wherein the method comprises:
charging and discharging the battery in a plurality of cycles, wherein the volume of the solid state cells changes during said plurality of cycles thereby exerting a load on the current collectors;
the deformation element starting to deform when the load on the current collector reaches a first threshold level, and
the rest of the current collector does not deform when the load on the current collector reaches a first threshold level.

16. The method according to claim 15, wherein during each of said plurality of cycles the solid state cells expand and contract, and during each cycle the deformation element deforms when the load on the current collector reaches a first threshold level as a result of one of expansion and contraction of the solid state cells and then returns towards its undeformed shape as the solid state cells undergo the other of expansion and contraction.
